(19) United States
(12) Patent Application Publication
(10) Pub. No.: US 2012/0311443 A1
(43) Pub. Date: Dec. 6, 2012

(54) DISPLAYING MENU OPTIONS FOR MEDIA ITEMS

(75) Inventors: Imran A. Chaudhri, San Francisco, CA (US); Lucas Newman, San Francisco, CA (US); Thomas Matthieu Alsina, Mountain View, CA (US)

(73) Assignee: APPLE INC., Cupertino, CA (US)

(21) Appl. No.: 13/486,533

(22) Filed: Jun. 1, 2012

Related U.S. Application Data
(60) Provisional application No. 61/493,067, filed on Jun. 3, 2011.

(51) Int. Cl. G06F 3/048

(52) U.S. Cl. 715/716

(57) ABSTRACT

A graphical user interface is presented on a display of a system showing a list of media item descriptions. The system can receive a first input from a user selecting a media item description from the displayed list. Responsive to receiving the first input, the system can display a menu on the user interface. The menu can include one or more icons selectable by the user. Each icon indicates an action that can be performed on a media item associated with the selected media item description. The system can receive a second input from the user selecting an icon from the one or more icons included in the menu. Responsive to receiving the second input, the system can perform the action associated with the selected icon on the selected media item. The system performs the action on the selected media item without disrupting the currently playing media item.

### CROSS-REFERENCE TO RELATED APPLICATIONS

This application claims priority to and the full benefit of U.S. Provisional Application Ser. No. 61/493,067, filed Jun. 3, 2011, and titled “DISPLAYING MENU OPTIONS FOR MEDIA ITEMS,” the entire contents of which are incorporated herein by reference.

### TECHNICAL FIELD

This disclosure relates generally to displaying menu options for media items on an electronic device.

### BACKGROUND

Modern media player applications provide graphical user interfaces for browsing, selecting, accessing or playing media content, such as music, video, audiobooks, electronic books, ringtones and applications. Media content may be browsed while some other media item is currently playing using the media player application. The user may select a media item while browsing and wish to perform an action on the media item (for example, add the media item to the playback queue) without disrupting the currently playing media item. If the media player application is running on a device with a limited screen size (for example, a smartphone or electronic tablet), it may be useful to display to the user a list of choices for the selected media item without leaving the currently displayed interface.

### SUMMARY

Methods, program products, and systems for displaying menu options for media items are disclosed. A graphical user interface is presented on a display of a system showing a list of media item descriptions. The system can receive a first input from a user selecting a media item description from the displayed list of media item descriptions. Responsive to receiving the first input, the system can display a menu on the user interface. The menu can include one or more icons that are selectable by the user. Each icon indicates an action that can be performed on a media item associated with the selected media item description. The system can receive a second input from the user selecting an icon from the one or more icons included in the menu. Responsive to receiving the second input, the system can determine the action associated with the selected icon and perform the action on the selected media item. The system can perform the action on the selected media item without disrupting the currently playing media item.

Particular implementations of displaying menu options for media items provide one or more of the following advantages. The user can select an icon that is associated with a play next action. Based upon the user selecting the icon associated with a play next action, the system can add the selected media item to the start of the playback queue without disrupting the currently playing media item. Therefore the selected media item is played by the system when the currently playing media item has completed playing.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIGS. 1A and 1B illustrate an exemplary graphical user interface (GUI) for displaying menu options for media item representations in an “artist” view.

FIGS. 2A and 2B illustrate an exemplary graphical user interface for displaying menu options for media item representations in an “album” view.

FIG. 3 is a flow diagram of an exemplary process for displaying menu options for a media item representation based on user selection of the media item representation.

FIG. 4 is a block diagram of an exemplary operating environment for an electronic device capable of displaying menu options for a media item representation based on user selection of the media item representation.

FIG. 5 is a block diagram of an exemplary device architecture that implements the features and processes described with reference to FIGS. 1-4.

Like reference symbols in the various drawings indicate like elements.

### DETAILED DESCRIPTION

### Exemplary Media Content Views

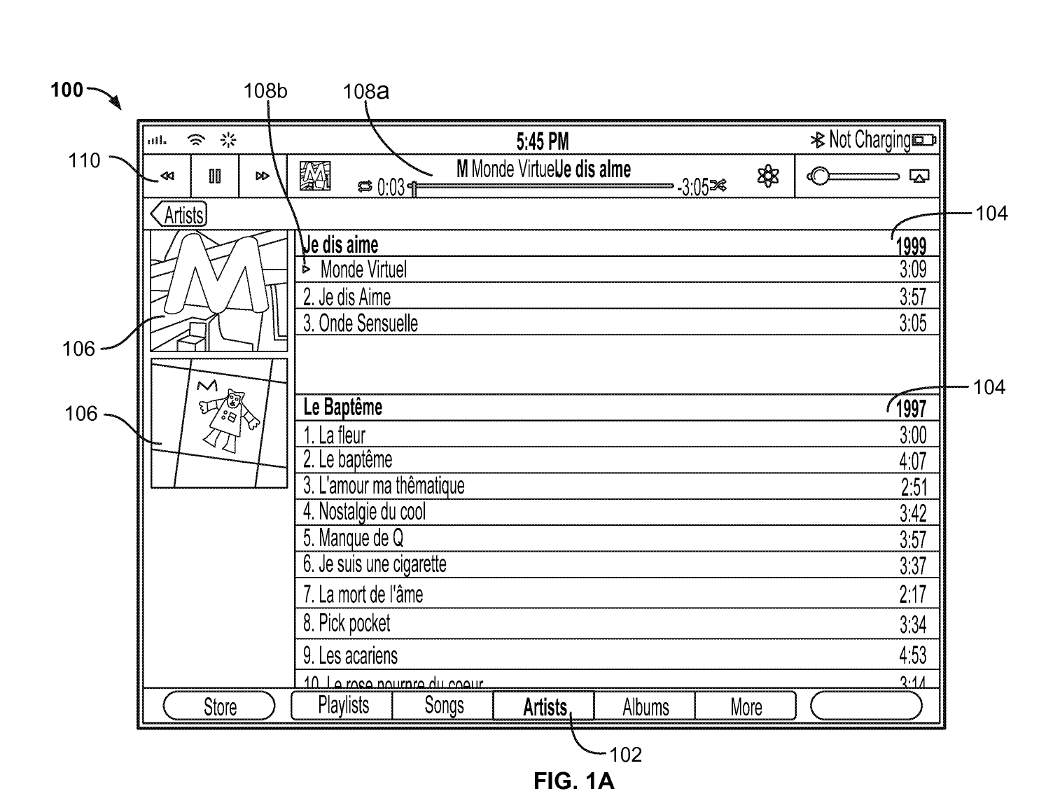

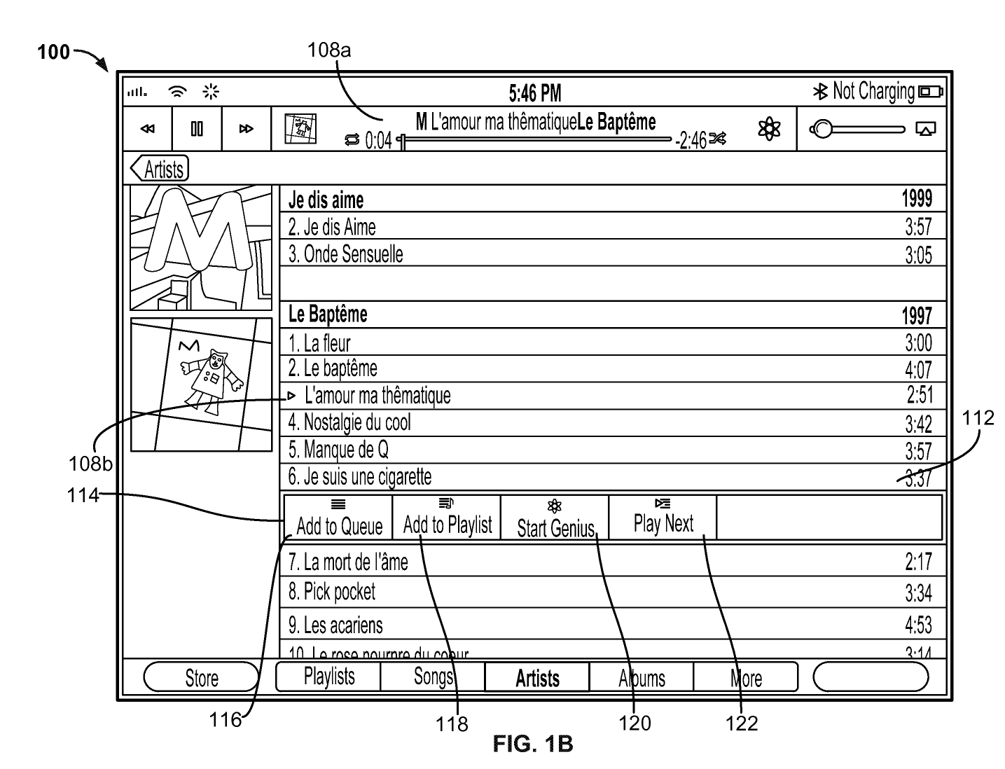

FIGS. 1A and 1B illustrate an exemplary graphical user interface (GUI) 100 for displaying menu options for media item representations in an “artist” view. In the example shown, the GUI 100 can be the GUI that is displayed for a media player application launched on an electronic device (for example, an electronic tablet) to play songs from a media library associated with the media player application. However, in alternative implementations, the media player application may be used to play or process other forms of media (for example, video, audiobooks, electronic books, ringtones and applications), with the GUI 100 displaying information associated with the other forms of media.

The GUI 100 illustrates the media player application in an “artist” view that shows all song titles of a selected artist present in the media library associated with the media player application. The media player application displays the GUI 100 when a user of the electronic device selects the “Artists” tab 102 at the bottom of the media player interface. The GUI 100 includes album titles and years 104 associated with displayed albums. Album art 106 associated with the albums are also displayed. Information on the song being currently played by the media player application is indicated in an area 108a and by an icon 108b on the GUI 100. The GUI 100 also includes controls 110 for controlling the currently playing song.

The “Artists” tab 102 can be selected by using a pointer operated by the user. If the display of electronic device is provided with a touch sensitive surface (for example, a touchscreen), the pointer may be a finger of the user that is used to touch an area of the display showing the “Artists” tab 102. Alternatively, the pointer may be a stylus that is used to touch an area of the display showing the “Artists” tab 102. In an alternative implementation, the pointer may be a computer mouse or a track pad that is maneuvered by the user to select the “Artists” tab 102.

When the user touches or otherwise interacts with the “Artists” tab 102, the interaction is processed by the media player application and/or other applications running on the electronic device that are configured to process external input to the device. Upon processing the user interaction, the media player application displays a list (not shown) of names of all the artists whose songs are present in the media library associated with the media player application. Upon the user selecting an artist from the displayed listing of artists, the media player application displays a listing of song titles of the selected artist, as shown by the GUI 100. The displayed song titles are grouped by the albums in which the songs are included. For example, the GUI 100 displays two albums of the selected artist. The album titles and years of the albums 104 are displayed at the top of the song listings for the albums. The album covers and/or other album art 106 are displayed in a column to the left of the song lists if the album covers and/or other album art associated with the albums are present in the media library.

The GUI 100 displays the currently playing song title in an area 108a at the top of the display. The area 108a shows the artist name, the title of the song currently playing and the title of the album containing the song. If the currently playing song is included in the list of songs displayed on the GUI 100, a “play” icon 108b is placed to the left of the song listing. As shown by the area 108a in the example illustrated by FIG. 1A, the artist name is “M” and the currently playing song title is “Monde Virtual” from the album “Je dis aime.” The GUI 100 displays a list of song titles by the artist “M” present in the media library, grouped by the albums 104, including the currently playing song title as indicated by the “play” icon 108b to the left of the song title.

The GUI 100 also displays icons 110 to the left of the area 108a for controlling the currently playing song. The icons 110 include rewind, pause/play and forward.

Therefore the user can browse a listing of song titles using the GUI 100 while the media player application is playing a song. In the course of browsing, the user may wish to select a song from the displayed listing to perform an action on the selected song without disrupting the currently playing song or without leaving the current GUI. If the electronic device is provided with a touchscreen, the user can select a song by touching an area of the touchscreen displaying the desired song title in the GUI. In one implementation, the user gesture can be an momentary tap on the touchscreen. In another implementation, the user maintains the touch with the area of the touchscreen for a small but finite period of time that is predetermined by the media player application.

When the user touches or otherwise interacts with the display showing the GUI, the media player application processes the user interaction to determine the song selected by the user, and then displays a menu on the GUI that indicates a list of actions that can be performed on the selected song. In one implementation, the media player application displays the menu in an area of the GUI that is adjacent to the selected song. However, in another implementation, the menu may be displayed at any position on the GUI or in a new GUI that hides the previous GUI. In the example shown in the GUI 100 of FIG. 1B, the user has selected the song title “Je suis une cigarette” 112 while the media player application is playing a different song, as indicated in the area 108a and also by the “play” icon 108b. Based on the user selecting the song 112 (for example, by touching the area of the screen of the electronic device directly above the song and maintaining the touch for the predetermined time), a menu 114 appears in view in the GUI 100 immediately below the selected song 112.

The menu 114 includes four icons in separate tabs, for example “Add to Queue” icon 116, “Add to Playlist” icon 118, “Start Genius” icon 120 and “Play Next” icon 122. As shown in FIG. 1B, displayed underneath each icon in the associated tab is text providing a brief description of the action associated with the icon. Each icon represents a different action that can be performed on the selected song. The user can select any one of the displayed icons to perform the associated action on the selected media item. In one implementation, the user can select only one icon from the menu and perform the associated action on the selected media item. In an alternative implementation, the user can select any number of icons from the menu and perform a series of actions associated with the selected icons on the selected media item.

If the user selects the “Add to Queue” icon 116 (for example, by touching the area of the screen of the electronic device directly above the Add to Queue” icon 116), the media player application adds the selected song to the end of the playback queue of the media player application such that the selected song is played by the media player application after all the songs that are placed before the selected song in the playback queue have been played. Otherwise, if the user selects the “Add to Playlist” icon 118, the media player application displays a new interface (not shown) with a list of the playlists that are stored associated with the media player application. Alternatively, or in addition to displaying the list of playlists, the media player application can also provide an option to create a new playlist. The user can select either one of the displayed playlists or create a new playlist, consequent to which the media player application adds the selected song to the selected playlist or the new playlist.

If the user selects the “Start Genius” icon 120, the media player application launches the Genius engine. The Genius engine is a component of the media player application that uses statistical data from libraries and playlists associated with all users to infer similarities with the selected song and generates a playlist of songs that match the determined similarities. In an alternative implementation, the Genius engine generates a playlist of songs that share a characteristic with the selected song. For example, the Genius engine may generate a playlist of songs that belong to the same genre of music as the selected song. The user can play all the songs in the generated playlist, or select specific songs to play, or save the playlist associated with the media player application in the memory of the electronic device.

The songs included in the generated playlist are songs that are present in the media library. In an alternative implementation, the generated playlist can include songs that are present in the media library and also songs that are present in a remote location on a network to which the electronic device is connected by one or more communications channels. The media player application may be configured to retrieve songs that are present in the remote location on the network when the songs in the generated playlist are played by the media player application.

If the user selects the “Play Next” icon 122, the media player application adds the selected song to the start of the playback queue of the media player application such that the selected song is played by the media player application immediately after the currently playing song has completed playing. Once the media player application has processed the action associated with the icon selected by the user, the media player application removes the menu 114 from the GUI 100 without disrupting the currently playing song. In an alternative implementation, the media player application maintains menu 114 visible on the GUI 100 in order to allow the user to select other icons to perform further actions on the selected song.

In one implementation, the menu 114 may include a “Play More Songs in This Genre” icon. If the user selects the “Play More Songs in This Genre” icon, the media player application determines which songs present in the media library are in the same genre of music as the selected song. If the media player application finds songs in the media library belonging to the same genre of music, then the media player application adds the found songs to the playback queue. The media player application may add a pre-determined number of the found songs to the playback queue. In an alternative implementation, the media player application may add all the found songs to the playback queue. The songs may be added at the start of the playback queue such that the newly added songs are played by the media player application immediately after the currently playing song has completed playing. In an alternative implementation, the found songs are added at the end of the playback queue such that the newly added songs are played by the media player application after all the preceding songs in the playback queue have completed playing.

In one implementation, the menu 114 also may include a “Play More Songs from This Artist” icon. If the user selects the “Play More Songs from This Artist” icon, the media player application determines which songs present in the media library has the same artist as the selected song. If the media player application finds songs in the media library from the same artist, then the media player application adds the found songs to the playback queue. The media player application may add a pre-determined number of the found songs to the playback queue. In an alternative implementation, the media player application may add all the found songs to the playback queue. The songs may be added at the start of the playback queue such that the newly added songs are played by the media player application immediately after the currently playing song has completed playing. In an alternative implementation, the found songs are added at the end of the playback queue such that the newly added songs are played by the media player application after all the preceding songs in the playback queue have completed playing.

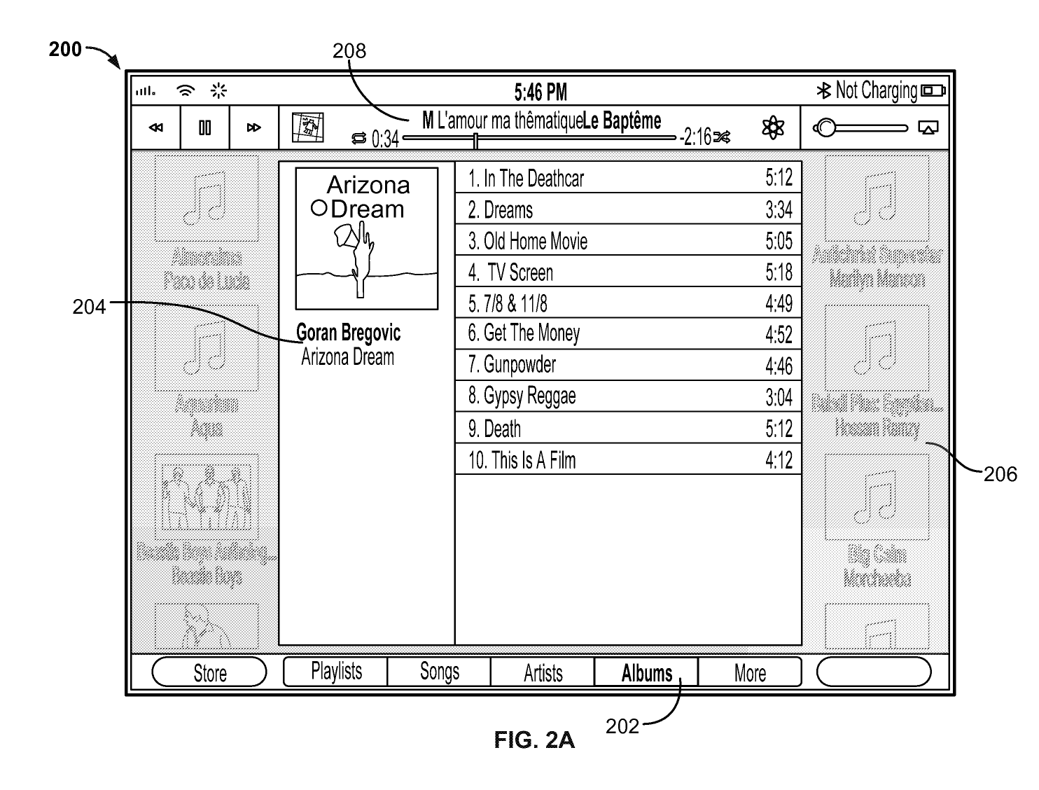

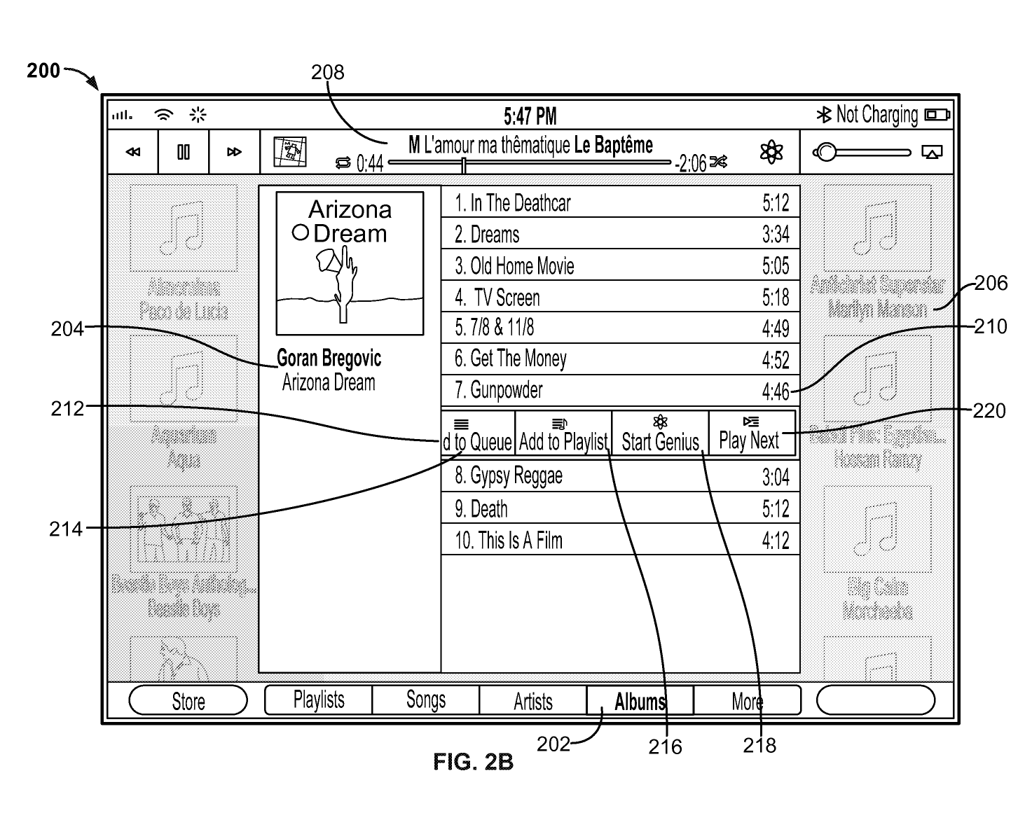

FIGS. 2A and 2B illustrate an exemplary GUI 200 for displaying menu options for media item representations in an “album” view. The GUI 200 can be the GUI that is displayed for a media player application launched on an electronic device (for example, an electronic tablet) to play songs from a media library associated with the media player application. However, in alternative implementations, the media player application may be used to play or process other forms of media (for example, video, audiobooks, electronic books, ringtones and applications), with the GUI 200 displaying information associated with the other forms of media.

The GUI 200 illustrates the media player application in an “album” view that shows all songs of a selected album that are present in the media library associated with the media player application. The media player application displays the GUI 200 when the user of the electronic device selects the “Album” tab 202 at the bottom of the media player interface. As illustrated in FIG. 2A, a window 204 in the foreground of the GUI 200 shows information associated with an album currently selected by the user. The background 206 of the GUI 200 is shaded and displays information associated with all the albums in the media library. Information associated with the currently playing song is shown in the song area 208.

The “Album” tab 202 can be selected by using a pointer operated by a user of the electronic device. If the display of electronic device is provided with a touch sensitive surface (for example, a touchscreen), the pointer may be a finger of the user that is used to touch an area of the display showing the “Album” tab 202. Alternatively, the pointer may be a stylus that is used to touch an area of the display showing the “Album” tab 202. In an alternative implementation, the pointer may be a computer mouse or a track pad that is maneuvered by the user to select the “Album” tab 202.

When the user touches or otherwise interacts with the “Albums” tab 202, the interaction is processed by the media player application and/or other applications running on the electronic device that are configured to process external input to the device. Upon processing the user interaction, the media player application displays information associated with all the albums that are present in the media library. The media player application displays the information in a container view, that is, displays images (for example, thumbnail images) of the album cover art or other album art (if the album cover art or other album art for corresponding albums are present in the media library) in a grid layout, with the title of the album and the name of the artist appearing under the image. If album art for an album is not present in the media library, the corresponding image shows a placeholder indicated by a music note icon. An example illustration of albums displayed in a container view is shown in the background 206 in FIGS. 2A and 2B.

The user can select an album from the displayed container view of albums by touching the area of the display over the album representation (if the display includes a touchscreen), or otherwise interacting with the container view of albums to select the desired album. Upon the user selection, the media player application displays the details of the album in a window 204 in the foreground of the user interface, as shown in the GUI 200. The window 204 is split into two columns. In a left column in the window 204, the media player application displays an image of the album art associated with the album that is present in the media library, with the name of the artist and the title of the album appearing in text below the image. The right column of the window 204 lists the songs belonging to the selected album that are present in the media library. In the example illustrated by FIGS. 2A and 2B, the window 204 indicates that the selected album is “Arizona Dream,” the album artist is “Goran Bregovic” and the media library has 10 songs of the album “Arizona Dream,” as displayed by the list in the right column of window 204, starting with the song “In The Deathcar” that is numbered “1,” and ending with the song “This Is A Film” that is numbered “10.”

When a selected album is displayed in the window 204 in the foreground of the GUI 200, the media player application shades the displayed container view of albums in the background 206 as shown in the example of FIGS. 2A and 2B. Shading the displayed container view of albums in the background 206 facilitates maintaining focus on the selected album in the window 204 in the foreground, amongst other uses.

The media player application displays the currently playing song in the area 208 at the top of the GUI 200, which is similar to the area 108a in GUI 100. The area 208 shows the artist name, the title of the song currently playing and the title of the album containing the song. The currently playing song can be from an album that is different from the album displayed in the window 204 in the foreground. In the example illustrated by FIG. 2A, as shown by the area 208, the artist name is “M”, the currently playing song is “L amour mathêmatique” and the album is “Le Baptême,” which is different from the album/artist shown in the window 204.

Therefore, as shown by the GUI 200, the user can browse albums included in the media library while the media player application is playing a song. In the course of browsing, the user may wish to select a song from the album displayed in the window 204 without disrupting the currently playing song or without leaving the current GUI 200. If the electronic device is provided with a touchscreen, the user can select a song by touching an area of the touchscreen displaying the desired song in the GUI. In one implementation, the user gesture can be an momentary tap on the touchscreen. In another implementation, the user maintains the touch with the area of the touchscreen for a small but finite period of time that is predetermined by the media player application.

When the user touches or otherwise interacts with the display showing the GUI 200 to select a song, the media player application processes the user interaction to determine the song selected by the user, and then displays a menu on the GUI that indicates a list of actions that can be performed on the selected song. In one implementation, the media player application displays the menu in an area of the GUI that is adjacent to the selected song. However, in another implementation, the menu may be displayed at any position on the GUI or in a new GUI that hides the previous GUI. In the example shown in the FIG. 2B, the user has selected the song “Gunpowder” 210 while the media player application is playing a different song, as indicated in the area 208. Based on the user selecting the song 210 (for example, by touching the area of the screen of the electronic device directly above the song and maintaining the touch for the predetermined time), the media player application displays a menu 212 on the GUI 200 immediately below the selected song 210.

The menu 212 is similar to the menu 114 of GUI 100. The menu 212 includes four icons in separate tabs—“Add to Queue” icon 214, “Add to Playlist” icon 216, “Start Genius” icon 218 and “Play Next” icon 220. As shown in FIG. 2A, displayed underneath each icon in the associated tab is text providing a brief description of the action associated with the icon. Each icon represents a different action that can be performed on the selected song. The user can select any one of the displayed icons to perform the associated action on the selected media item. In one implementation, the user can select only one icon from the menu and perform the associated action on the selected media item. In an alternative implementation, the user can select any number of icons from the menu and perform a series of actions associated with the selected icons on the selected media item.

If the user selects the “Add to Queue” icon 214 (for example, by touching the area of the screen of the electronic device directly above the Add to Queue” icon 214), the media player application adds the selected song to the end of the playback queue of the media player application such that the selected song is played by the media player application after all the songs that are placed before the selected song in the playback queue have been played. Otherwise, if the user selects the “Add to Playlist” icon 216, the media player application displays a new interface (not shown) with a list of the playlists that are stored associated with the media player application. Alternatively, or in addition to displaying the list of playlists, the media player application can also provide an option to create a new playlist. The user can select either one of the displayed playlists or create a new playlist, consequent to which the media player application adds the selected song to the selected playlist or the new playlist.

If the user selects the “Start Genius” icon 218, the media player application launches the Genius engine. The Genius engine is a component of the media player application that uses statistical data from libraries and playlists associated with all users to infer similarities with the selected song and generates a playlist of songs that match the determined similarities. In an alternative implementation, the Genius engine generates a playlist of songs that share a characteristic with the selected song. For example, the Genius engine may generate a playlist of songs that belong to the same genre of music as the selected song. The user can play all the songs in the generated playlist, or select specific songs to play, or save the playlist associated with the media player application in the memory of the electronic device.

The songs included in the generated playlist are songs that are present in the media library. In an alternative implementation, the generated playlist can include songs that are present in the media library and also songs that are present in a remote location on a network to which the electronic device is connected by one or more communications channels. The media player application may be configured to retrieve songs that are present in the remote location on the network when the songs in the generated playlist are played by the media player application.

If the user selects the “Play Next” icon 220, the media player application adds the selected song to the start of the playback queue of the media player application such that the selected song is played by the media player application immediately after the currently playing song has completed playing. Once the media player application has processed the action associated with the icon selected by the user, the media player application removes the menu 212 from the GUI 200 without disrupting the currently playing song. In an alternative implementation, the media player application maintains menu 212 visible on the GUI 200 in order to allow the user to select other icons to perform further actions on the selected song.

In one implementation, the menu 212 may include a “Play More Songs in This Genre” icon. If the user selects the “Play More Songs in This Genre” icon, the media player application determines which songs present in the media library are in the same genre of music as the selected song. If the media player application finds songs in the media library belonging to the same genre of music, then the media player application adds the found songs to the playback queue. The media player application may add a pre-determined number of the found songs to the playback queue. In an alternative implementation, the media player application may add all the found songs to the playback queue. The songs may be added at the start of the playback queue such that the newly added songs are played by the media player application immediately after the currently playing song has completed playing. In an alternative implementation, the found songs are added at the end of the playback queue such that the newly added songs are played by the media player application after all the preceding songs in the playback queue have completed playing.

In one implementation, the menu 212 also may include a “Play More Songs from This Artist” icon. If the user selects the “Play More Songs from This Artist” icon, the media player application determines which songs present in the media library has the same artist as the selected song. If the media player application finds songs in the media library from the same artist, then the media player application adds the found songs to the playback queue. The media player application may add a pre-determined number of the found songs to the playback queue. In an alternative implementation, the media player application may add all the found songs to the playback queue. The songs may be added at the start of the playback queue such that the newly added songs are played by the media player application immediately after the currently playing song has completed playing. In an alternative implementation, the found songs are added at the end of the playback queue such that the newly added songs are played by the media player application after all the preceding songs in the playback queue have completed playing.

In one implementation, the media player application may display a menu when the user selects a thumbnail image of an album when the container view of albums is displayed on the GUI of the media player application, for example as shown in the background 206 in the example of FIGS. 2A and 2B. If the electronic device is provided with a touchscreen, the user can select an album by touching an area of the touchscreen displaying an image or icon of the desired album in the GUI. When the user touches or otherwise interacts with the display showing the albums in container view to select an album, the media player application may process the user interaction to determine the album selected by the user, and then display a menu on the GUI that indicates a list of actions that can be performed on the selected album. The media player application may display the menu in an area of the GUI that is adjacent to the selected album. However, in another implementation, the menu may be displayed at any position on the GUI or in a new GUI that hides the previous GUI.

The menu that is displayed on the GUI for the selected album may include an “Add All Songs to the Queue” icon. If the user selects the “Add All Songs to the Queue” icon, the media player application adds all the songs from the selected album that are in the media library to the playback queue. The songs are added at the end of the playback queue such that the newly added songs are played by the media player application after all the preceding songs in the playback queue have completed playing.

The menu displayed for the selected album also may include a “Play All Songs Next” icon. If the user selects the “Play All Songs Next” icon, the media player application adds all the songs from the selected album that are in the media library to the start of the playback queue such that the songs from the selected album are played by the media player application immediately after the currently playing song has completed playing.

### Exemplary Processes

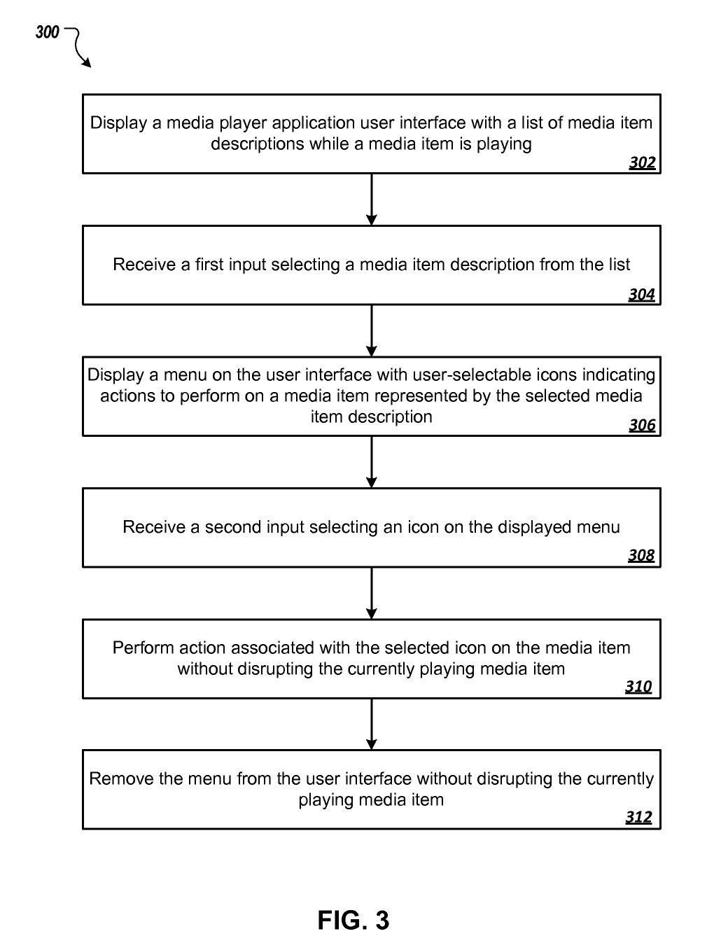

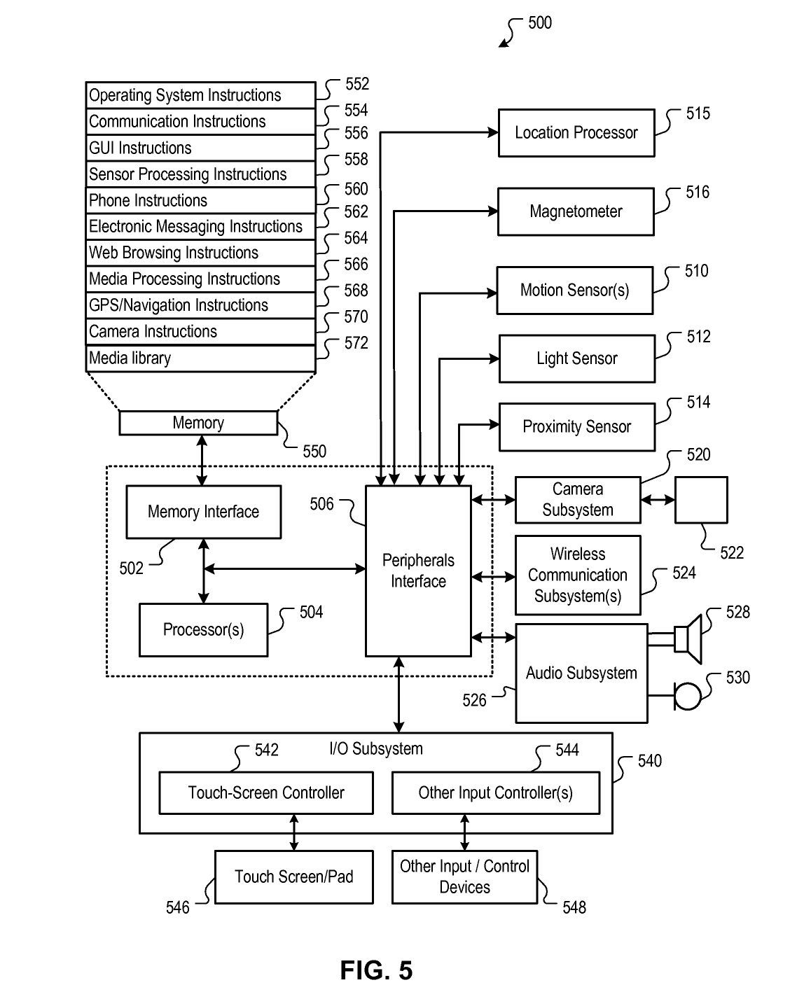

FIG. 3 is a flow diagram of an exemplary process 300 for displaying menu options for a media item representation based on user selection of the media item representation. Process 300 can be implemented by device architecture 500, as described in reference to FIG. 5. In the following sections, the process 300 is described as being performed by an electronic device displaying the GUI 100 and the GUI 200 that are described with reference to FIGS. 1A-1B and 2A-2b respectively. However, the process 300 may be performed by other devices or system configurations.

In some implementations, the process 300 can begin with the media player application included in the electronic device displaying a user interface with a list of media item descriptions (302). For example, the media player application can display the GUI 100 showing a list of song titles in an “Artists” view. Alternatively, the media player application can display the GUI 200 showing a list of song titles from an album in an “Albums” view. The user interface is displayed by the media player application based on the user selecting an option indicated by the media player application that is running on the electronic device. The media player application may already be running on the electronic device when the user makes a selection, or the user may launch the media player application and then make a selection. For example, as described previously with reference to FIGS. 1A and 1B, to display the GUI 100, the user selects the “Artists” tab 102 at the bottom of the media player interface of the media player application that is running on the electronic device.

When a list of media item descriptions is displayed on the user interface of the media player application (302), the media player application, and/or other applications running on the electronic device that are configured to process external input to the device, may receive a first input associated with selecting a media item description from the list that is displayed (304). For example, when the media player application displays a listing of songs by an artist as shown in the GUI 100, the user can browse the listing of songs and select a song from the displayed listing. If the electronic device is provided with a touchscreen, the user can select a song by touching an area of the touchscreen displaying the desired song in the GUI. When the user touches or otherwise interacts with the display showing the GUI of the media player application to select a song, the interaction is processed by the media player application (and/or other applications running on the electronic device that are configured to process external input to the device) as a first input indicating that the song is selected by the user.

Upon processing the first input, the media player application displays a menu on the user interface with user-selectable icons indicating actions that can be performed on the media item represented by the selected media item description (306). For example, as shown in FIG. 1B, based on processing the user's interaction with the display showing the GUI 100, the media player application displays the menu 114 on the GUI 100 immediately below the selected song description 112. In an alternative implementation, the menu 114 can appear anywhere on the GUI 100 or on a different GUI than the GUI 100. As shown in FIG. 1B, the menu 114 includes four icons 116, 118, 120 and 122 in separate tabs, with each icon representing an action that can be performed on the selected song—the “Add to Queue” icon 116 indicating adding the selected song 112 to the playback queue, the “Add to Playlist” icon 118 indicating adding the selected song 112 to a playlist, the “Start Genius” icon 118 indicating launching the Genius selection engine and the “Play Next” icon 120 indicating adding the selected song 112 to the start of the playback queue. Therefore using the menu 114 the user can perform one of four actions on the selected song. However, in an alternative implementation, the menu 114 may include a different number of icons indicating a different set of actions that can be performed on the selected song.

Subsequent to displaying the menu on the user interface, the media player application (and/or other applications running on the electronic device that are configured to process external input to the device), may receive a second input associated with selecting an icon on the displayed menu (308). For example, continuing with the illustration of FIGS. 1A and 1B, the user may select one of the four icons 116, 118, 120 or 122. The user may make the selection by touching the area of the screen of the electronic device directly above the desired icon. When the user touches or otherwise interacts with the display showing the GUI 100 to select an icon, the interaction is processed by the media player application (and/or other applications running on the electronic device that are configured to process external input to the device) as a second input and determines that the action associated with the selected icon is to be performed on the selected song.

Based on the determination of the icon that is selected by the user, the media player application performs the action associated with the selected icon on the media item without disrupting the currently playing media item (310). In the example shown in FIG. 1B, the user may select the “Play Next” icon 120 by touching an area of the display showing the area of the GUI with the “Play Next” icon 120. The media player application processes the interaction and determines that the user has selected the “Play Next” icon 120. The media player application adds the selected song to the start of the playback queue of the media player application such that the selected song is played by the media player application immediately after the currently playing song has completed playing.

After the second input is received, the media player application removes the menu from the user interface without disrupting the currently playing media item (312). In the example shown in FIG. 1B, once the media player application has processed the action associated with the icon selected by the user, the media player application removes the menu 114 from the GUI 100 without disrupting the currently playing song. In an alternative implementation, the media player application maintains menu 114 visible on the GUI 100 in order to allow the user to select other icons to perform further actions on the selected song.

### Exemplary Operating Environment

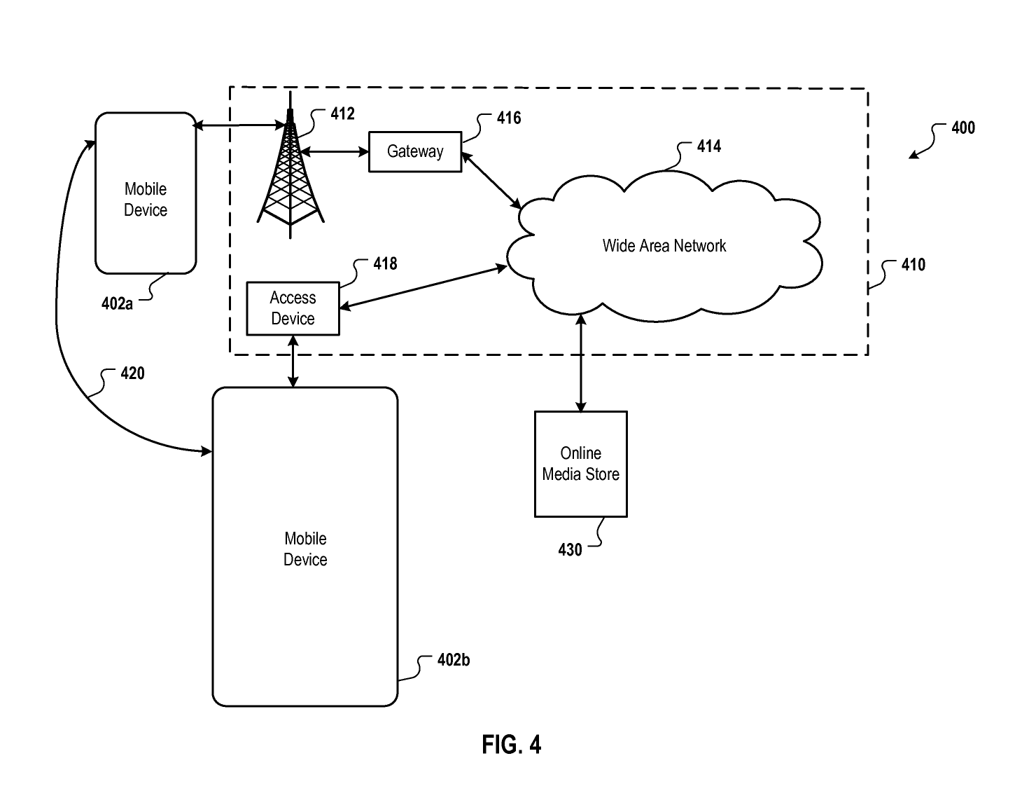

FIG. 4 is a block diagram of an exemplary operating environment for an electronic device capable of displaying menu options for a media item representation based on user selection of the media item representation. The devices 402a and 402b can be electronic devices that include media player applications configured to display menu options for a media item representation selected by the users of the devices 402a and 402b. In one implementation, the devices 402a and 402b are mobile devices that can communicate over one or more wired or wireless networks 410. For example, a wireless network 412 (for example, a cellular network) can communicate with wide area network (WAN) 414, such as the Internet, by use of gateway 416. Likewise, access device 418, such as an 802.11g wireless access device (for example, a router), can provide communication access to WAN 414.

In some implementations, both voice and data communications can be established over wireless network 412 and access device 418. For example, mobile device 402a can place and receive phone calls (for example, using voice over Internet Protocol (VoIP)), send and receive e-mail messages (for example, using Post Office Protocol 3 (POP3)), and retrieve electronic documents or streams, such as Web pages, photographs, and videos, over wireless network 412, gateway 416, and WAN 414 (for example, using Transmission Control Protocol/Internet Protocol (TCP/IP) or User Datagram Protocol (UDP)). Likewise, in some implementations, mobile device 402b can place and receive phone calls, send and receive e-mail messages, and retrieve electronic documents over access device 418 and WAN 414. In some implementations, mobile device 402a or 402b can be physically connected to access device 418 using one or more cables and access device 418 can be a personal computer. In this configuration, mobile device 402a or 402b can be referred to as a “tethered” device.

Mobile devices 402a and 402b can also establish communications by other means. For example, mobile device 402a can communicate with other wireless devices, for example, other mobile devices, cell phones, etc., over wireless network 412. Likewise, mobile devices 402a and 402b can establish peer-to-peer communications 420, for example, a personal area network (PAN), by use of one or more communication technologies, such as BLUETOOTH™. Other communication protocols and topologies can also be implemented.

Mobile device 402a or 402b can communicate with one or more services over the one or more wired or wireless networks 412. For example, one or more online stores or services 430 can provide a marketplace for users to purchase and down load media, such as music, video, applications, ringtones, audio books, electronic books and the like.

Mobile device 402a or 402b can also access other data and content over the one or more wired and/or wireless networks 412. For example, content publishers, such as news sites, Rally Simple Syndication (RSS) feeds, web sites, blogs, social networking sites, developer networks, etc., can be accessed by mobile device 402a or 402b. Such access can be provided by invocation of a web browsing function or application (for example, a browser) in response to a user touching, for example, a Web display object on a screen of mobile device 402a or 402b.

### Exemplary Device Architecture

FIG. 5 is a block diagram illustrating exemplary device architecture implementing features and operations described in reference to FIGS. 1-4. Device 500 can be any device that includes media player applications configured to display menu options for a media item representation selected by a user of the device, including but not limited to smart phones and electronic tablets. Device 500 can include memory interface 502, one or more data processors, image processors or central processing units 504, and peripherals interface 506. Memory interface 502, processor(s) 504 or peripherals interface 506 can be separate components or can be integrated in one or more integrated circuits. The various components can be coupled by one or more communication buses or signal lines.

Sensors, devices, and subsystems can be coupled to peripherals interface 506 to facilitate multiple functionalities. For example, motion sensor 510, light sensor 512, and proximity sensor 514 can be coupled to peripherals interface 506 to facilitate orientation, lighting, and proximity functions of the mobile device. For example, in some implementations, light sensor 512 can be utilized to facilitate adjusting the brightness of touch screen 546. In some implementations, motion sensor 510 (for example, an accelerometer or gyroscope) can be utilized to detect movement and orientation of the device 500. Accordingly, display objects or media can be presented according to a detected orientation, for example, portrait or landscape.

Other sensors can also be connected to peripherals interface 506, such as a temperature sensor, a biometric sensor, or other sensing device, to facilitate related functionalities.

Location processor 515 (for example, GPS receiver) can be connected to peripherals interface 506 to provide geo-positioning. Electronic magnetometer 516 (for example, an integrated circuit chip) can also be connected to peripherals interface 506 to provide data that can be used to determine the direction of magnetic North. Thus, electronic magnetometer 516 can be used as an electronic compass.

Camera subsystem 520 and an optical sensor 522, for example, a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 524. Communication subsystem(s) 524 can include one or more wireless communication subsystems. Wireless communication subsystems 524 can include radio frequency receivers and transmitters and/or optical (for example, infrared) receivers and transmitters. Wired communication system can include a port device, for example, a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 524 can depend on the communication network(s) or medium(s) over which device 500 is intended to operate. For example, a mobile device can include communication subsystems 524 designed to operate over a GSM network, a GPRS network, an EDGE network, a Wi-Fi or WiMAX network, and a Bluetooth network. In particular, the wireless communication subsystems 524 can include For example, device 500 may include wireless communication subsystems designed to operate over a global system for mobile communications (GSM) network, a GPRS network, an enhanced data GSM environment (EDGE) network, 802.x communication networks (for example, Wi-Fi ______33, WiMAX, or 3G networks), code division multiple access (CDMA) networks, and a Bluetooth™ network. Communication subsystems 524 may include hosting protocols such that the mobile device 500 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 526 can be coupled to a speaker 528 and one or more microphones 530 to facilitate voice-enabled functions, such as voice recognition, voice replication, digital recording, and telephony functions.

I/O subsystem 540 can include touch screen controller 542 and/or other input controller(s) 544. Touch-screen controller 542 can be coupled to a touch screen 546 or pad. Touch screen 546 and touch screen controller 542 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen 546.

Other input controller(s) 544 can be coupled to other input/control devices 548, such as one or more buttons, rocker switches, thumb-wheel, infrared port, USB port, and/or a pointer device such as a stylus. The one or more buttons (not shown) can include an up/down button for volume control of speaker 528 and/or microphone 530.

In one implementation, a pressing of the button for a first duration may disengage a lock of the touch screen 546; and a pressing of the button for a second duration that is longer than the first duration may turn power to mobile device 500 on or off. The user may be able to customize a functionality of one or more of the buttons. The touch screen 546 can also be used to implement virtual or soft buttons and/or a keyboard.

In some implementations, device 500 can present recorded audio and/or video files, such as MP3, AAC, and MPEG files. In some implementations, device 500 can include the functionality of an MP3 player and may include a pin connector for tethering to other devices. Other input/output and control devices can be used.

Memory interface 502 can be coupled to memory 550. Memory 550 can include high-speed random access memory or non-volatile memory, such as one or more magnetic disk storage devices, one or more optical storage devices, or flash memory (for example, NAND, NOR). Memory 550 can store operating system 552, such as DARWIN, RTXC, LINUX, UNIX, OS X, WINDOWS, or an embedded operating system such as VXWORKS. Operating system 552 may include instructions for handling basic system services and for performing hardware dependent tasks. In some implementations, operating system 552 can include a kernel (for example, UNIX kernel).

Memory 550 may also store communication instructions 554 to facilitate communicating with one or more additional devices, one or more computers or one or more servers. Communication instructions 554 can also be used to select an operational mode or communication medium for use by the device, based on a geographic location (obtained by the GPS/Navigation instructions 568) of the device. Memory 550 may include graphical user interface instructions 556 to facilitate graphical user interface processing of the GUIs shown in FIGS. 1A-1B and 2A-2B; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions, including the various actions in menu 212; GPS/Navigation instructions 568 to facilitate GPS and navigation-related processes and instructions; camera instructions 570 to facilitate camera-related processes and functions and media library 572 for the storage of media items described with reference to FIGS. 1-4. The memory 550 may also store other software instructions for facilitating other processes, features and applications.

Each of the above identified instructions and applications can correspond to a set of instructions for performing one or more functions described above. These instructions need not be implemented as separate software programs, procedures, or modules. Memory 550 can include additional instructions or fewer instructions. Furthermore, various functions of the mobile device may be implemented in hardware and/or in software, including in one or more signal processing and/or application specific integrated circuits.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (for example, OBJECTIVE-C, JAVA), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to, communicate with, one or more mass storage devices for storing data files; such devices include magnetic disks, such as internal hard disks and removable disks; magneto-optical disks; and optical disks.

Storage devices suitable for tangibly embodying computer program instructions and data include all forms of non-volatile memory, including by way of semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a player, the features can be implemented on a computer having a display device, such as a CRT (cathode ray tube) or LCD (liquid crystal display) monitor for displaying information to the player. The computer can also have a keyboard and a pointing device such as a game controller, mouse or a trackball by which the player can provide input to the computer.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include LAN, WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (for example, an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
causing a graphical user interface to be displayed including a list of media item descriptions;
receiving a first input associated with selecting a media item description from the list;
based on receiving the first input, displaying a menu on the user interface, the menu including one or more user-selectable icons indicating one or more actions that can be performed on a media item associated with the selected media item description;
receiving a second input associated with selecting an icon from the one or more icons; and
based on receiving the second input, performing an action associated with the selected icon on the media item without disrupting a currently playing media item,
where the method is performed by one or more hardware processors.

2. The method of claim 1, wherein receiving the second input associated with selecting an icon from the one or more icons further comprises:
determining that the selected icon is associated with an add to queue action; and
based on determining that the selected icon is associated with an add to queue action, placing the media item at an end of a playback queue of a media player application without disrupting the currently playing media item.

3. The method of claim 1, wherein receiving the second input associated with selecting an icon from the one or more icons further comprises:
determining that the selected icon is associated with an add to playlist action; and
based on determining that the selected icon is associated with an add to playlist action, placing the media item at an end of a playlist of a media player application without disrupting the currently playing media item.

4. The method of claim 1, wherein receiving the second input associated with selecting an icon from the one or more icons further comprises:
determining that the selected icon is associated with a start genius action that is associated with a selection engine for generating playlists; and
based on determining that the selected icon is associated with a start genius action, launching a selection engine, wherein the selection engine is configured to generate a playlist including media items that share at least one characteristic with the media item selected based on the first input.

5. The method of claim 1, wherein receiving the second input associated with selecting an icon from the one or more icons further comprises:
determining that the selected icon is associated with a play next action; and
based on determining that the that the selected icon is associated with a play next action, placing the media item at a start of a playback queue of a media player application without disrupting a currently playing media item such that the media item is played by the media player application when the currently playing media item has completed playing.

6. The method of claim 1, the method further comprising:
removing the menu from the user interface such that the menu is no longer visible on the user interface.

7. The method of claim 1, the method further comprising:
receiving a third input making a second selection from the one or more icons, the second selection selecting an icon that is different from the icon associated with the second input; and
based on receiving the third input, performing, on the media item, a second action associated with the icon selected by the second selection without disrupting a currently playing media item.

8. The method of claim 1, wherein displaying a menu on the user interface further comprises:
displaying the menu on the user interface for a pre-determined period of time; and
upon expiration of the pre-determined period of time without receiving an input with the pre-determined period of time, removing the menu from the user interface without performing any action on the media item.

9. The method of claim 1, wherein the media item is a song.

10. The method of claim 1, wherein the list of media item descriptions includes an album associated with the list of media item descriptions.

11. The method of claim 1, wherein the list of media item descriptions includes media items generated by an artist.

12. The method of claim 1, wherein the first input includes a user gesture using a display surface of a device displaying the user interface, the user gesture including a touch on an area of the display displaying the selected media item description.

13. The method of claim 12, wherein the display surface of the device includes a touch sensitive surface.

14. The method of claim 1, wherein the second input includes a user gesture using a display surface of a device displaying the user interface, the user gesture including a touch on an area of the display surface displaying an icon from the one or more icons included in the menu.

15. A method comprising:
causing a graphical user interface to be displayed including a list of media item descriptions;
receiving a first input associated with selecting a media item description;
based on receiving the first input, displaying a menu on the graphical user interface adjacent to the selected media item description, the menu including one or more user-selectable icons, with each icon indicating an action that can be performed on a media item associated with the selected media item description;
receiving a second input associated with selecting an icon from the one or more icons;
based on receiving the second input, determining which icon from the one or more icons is selected; and
based on determining that the selected icon is associated with a play next action, placing the media item at a start of a playback queue of a media player application without disrupting a currently playing media item such that the media item is played by the media player application when the currently playing media item has completed playing,
where the method is performed by one or more hardware processors.

16. A method comprising:
causing, using a touchscreen display of a device, a graphical user interface to be displayed including a list of media item descriptions;
receiving, based on a first user gesture using the touchscreen display, a first input associated with selecting a media item description;
based on receiving the first input, displaying a menu on the graphical user interface adjacent to the selected media item description, the menu including one or more user-selectable icons, with each icon indicating an action that can be performed on a media item associated with the selected media item description;
receiving, based on a second user gesture using the touchscreen display, a second input associated with selecting an icon from the one or more icons;
determining which icon from the one or more icons is selected;
based on determining that the selected icon is associated with an add to queue action, placing the media item at an end of a playback queue of a media player application without disrupting a currently playing media item;
based on determining that the selected icon is associated with an add to playlist action, placing the media item at an end of a playlist of a media player application without disrupting the currently playing media item;
based on determining that the selected icon is associated with a start genius action that is associated with a selection engine for generating playlists, launching a selection engine, wherein the selection engine is configured to generate a playlist including media items that share at least one characteristic with the media item selected based on the first input;
based on determining that the selected icon is associated with a play next action, placing the media item at a start of a playback queue of a media player application without disrupting a currently playing media item such that the media item is played by the media player application when the currently playing media item has completed playing; and
removing the menu from the graphical user interface such that the menu is no longer visible on the graphical user interface,
where the method is performed by one or more hardware processors.

17. A system comprising:
one or more processors;
non-transitory machine-readable memory configured for storing instructions, which, when executed by the one or more processors, causes the one or more processors to perform operations comprising:
causing a graphical user interface to be displayed including a list of media item descriptions;
receiving a first input associated with selecting a media item description from the list;
based on receiving the first input, displaying a menu on the user interface that is shown on the display, the menu including one or more user-selectable icons indicating one or more actions that can be performed on a media item associated with the selected media item description;
receiving a second input associated with selecting an icon from the one or more icons; and
based on receiving the second input, performing an action associated with the selected icon on the media item without disrupting a currently playing media item.

18. The system of claim 17, wherein receiving the second input associated with selecting an icon from the one or more icons further comprises:
determining that the selected icon is associated with a play next action; and
based on determining that the selected icon is associated with a play next action, placing the media item at a start of a playback queue of a media player application without disrupting a currently playing media item such that the media item is played by the media player application when the currently playing media item has completed playing.

19. The system of claim 17, where the one or more processors are configured for performing operations comprising:
removing the menu from the user interface such that the menu is no longer visible on the user interface.

20. A system comprising:
one or more processors;
non-transitory machine-readable memory configured for storing instructions, which, when executed by the one or more processors, causes the one or more processors to perform operations comprising:
causing a graphical user interface to be displayed including a list of media item descriptions;
receiving a first input associated with selecting a media item description;
based on receiving the first input, displaying a menu on the graphical user interface adjacent to the selected media item description, the menu including one or more user-selectable icons, with each icon indicating an action that can be performed on a media item associated with the selected media item description;
receiving a second input associated with selecting an icon from the one or more icons;
based on receiving the second input, determining which icon from the one or more icons is selected; and
based on determining that the selected icon is associated with a play next action, placing the media item at a start of a playback queue of a media player application without disrupting a currently playing media item such that the media item is played by the media player application when the currently playing media item has completed playing.
